(19) United States
(12) Patent Application Publication
(10) Pub. No.: US 2022/0134846 A1
(43) Pub. Date: May 5, 2022

(54) Magnetic Kinematic HVAC Control

(71) Applicant: DENSO International America, Inc., Southfield, MI (US)

(72) Inventors: Misael OSTRIA, Sahagun City (MX); Jason WAGNITZ, Pinckney, MI (US)

(21) Appl. No.: 17/212,648

(22) Filed: Mar. 25, 2021

Related U.S. Application Data
(60) Provisional application No. 63/109,411, filed on Nov. 4, 2020.

(51) Int. Cl. B60H 1/34

(52) U.S. Cl. CPC B60H 1/3414; B60H 2001/3471

(57) ABSTRACT

An (HVAC) system having an HVAC case. An airflow control member is mounted within the HVAC case. A first magnet is at or adjacent to the axis of rotation and movable along with the airflow control member. The first magnet generates a first magnetic field. A second magnet is spaced apart from the first magnet. The second magnet generates a second magnetic field having a polarity that is opposite to the first magnetic field. Magnetic cooperation between the first magnet and the second magnet provides a magnetic linkage for rotating the airflow control member within the HVAC case.

### CROSS-REFERENCE TO RELATED APPLICATION

This application claims the benefit of U.S. Provisional Application No. 63/109,411 filed on Nov. 4, 2020, the entire disclosure of which is incorporated herein by reference.

### FIELD

The present disclosure relates to a heating, ventilation, and air conditioning (HVAC) system including an airflow control member actuated by a magnetic linkage.

### BACKGROUND

This section provides background information related to the present disclosure, which is not necessarily prior art.

Vehicle heating, ventilation, and air conditioning (HVAC) systems include a plurality of airflow control doors. With existing HVAC systems, each door is moved by a complex mechanical linkage, which requires many injection molded parts. Mechanical linkages are expensive and complex to make, and also undesirably create noise due to friction and other external forces. While mechanical linkages are suitable for their intended use, they are subject to improvement. The present disclosure advantageously provides for improved HVAC door linkages including the features described herein.

### SUMMARY

This section provides a general summary of the disclosure, and is not a comprehensive disclosure of its full scope or all of its features.

The present disclosure includes an (HVAC) system having an HVAC case. An airflow control member is mounted within the HVAC case. A first magnet is at or adjacent to the axis of rotation and movable along with the airflow control member. The first magnet generates a first magnetic field. A second magnet is spaced apart from the first magnet. The second magnet generates a second magnetic field having a polarity that is opposite to the first magnetic field. Magnetic cooperation between the first magnet and the second magnet provides a magnetic linkage for rotating the airflow control member within the HVAC case.

The present disclosure further provides for an HVAC system with an HVAC case and an airflow control member mounted within the HVAC case. A servomotor is mounted to the HVAC case. A magnetic linkage is between the airflow control member and the servomotor. The servomotor rotates the airflow control door by way of the magnetic linkage.

The present disclosure further includes an (HVAC) system with an HVAC case. An airflow control member is mounted to the HVAC case and rotatable on an axis of rotation. A first magnet is mounted to the airflow control member. A plurality of second magnets are mounted to the HVAC case about the first magnet. A control module is configured to individually control polarity of each one of the plurality of the second magnets to move the first magnet to one of the plurality of second magnets, thereby rotating the airflow control member on the axis of rotation.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an HVAC system including an HVAC case, the HVAC case has an airflow control member actuated by a magnetic linkage in accordance with the present disclosure;

FIG. 2 is a perspective view of the mechanical linkage shown apart from the HVAC case for increased clarity;

FIG. 3 is a side view of the HVAC case including another magnetic linkage in accordance with the present disclosure; and

FIG. 4 illustrates area 4 of FIG. 3.

Corresponding reference numerals indicate corresponding parts throughout the several views of the drawings.

### DETAILED DESCRIPTION

Example embodiments will now be described more fully with reference to the accompanying drawings.

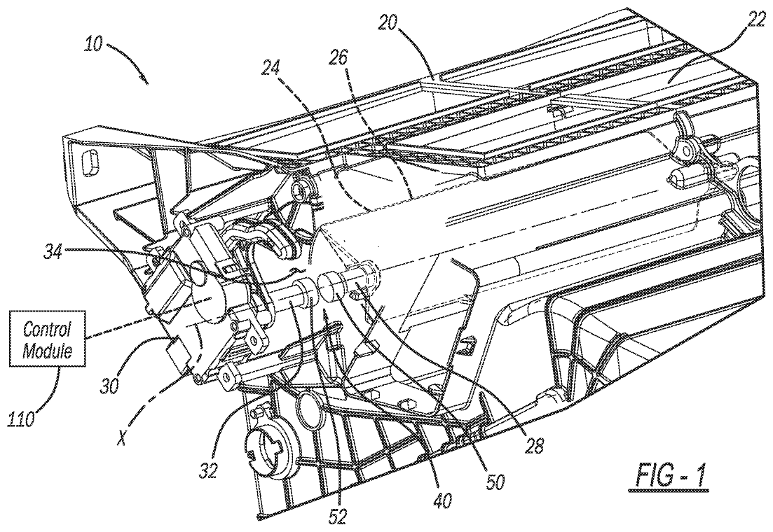

FIG. 1 illustrates a heating, ventilation, and air-conditioning system (HVAC) 10 in accordance with the present disclosure. The HVAC system 10 may be configured for use in any suitable application, such as any suitable vehicular or non-vehicular application. With respect to vehicular applications, the HVAC system 10 may be configured for use with any suitable passenger vehicle, mass-transit vehicle, recreational vehicle, military vehicle/equipment, construction vehicle/equipment, watercraft, aircraft, etc.

The HVAC system 10 includes an HVAC case 20. The HVAC case 20 may house any suitable cooling and heating devices, such as an evaporator and heater core. The HVAC case 20 defines a plurality of airflow outlets 22, through which conditioned airflow exits the HVAC case 20. Airflow through the airflow outlets 22 is controlled by one or more airflow control members 24. In the example illustrated, the airflow control member 24 includes a panel 26, which is movable to direct and block airflow through the airflow outlets 22. The airflow control members 24 may be doors, valves, or any other suitable device, member, assembly, etc. suitable for controlling airflow. The HVAC case 20 may also include a plurality of additional airflow control members within the HVAC case 20 controlling airflow through the evaporator and heater core. The description of the airflow control member 24 also applies to any of the other airflow control members of the HVAC case 20.

Mounted to the HVAC case 20 is any suitable motor for rotating the airflow control member 24. In the example illustrated, the motor is a servomotor (“servo”) 30. The servomotor 30 rotates the airflow control member 24 on a rotation axis X by way of a magnetic linkage 40. Operation of the servomotor 30 is controlled by any suitable control module 110. In this application, the term “control module” may be replaced with the term “circuit.” The term “control module” may refer to, be part of, or include processor hardware (shared, dedicated, or group) that executes code and memory hardware (shared, dedicated, or group) that stores code executed by the processor hardware. The code is configured to provide the features of the control module 110 described herein.

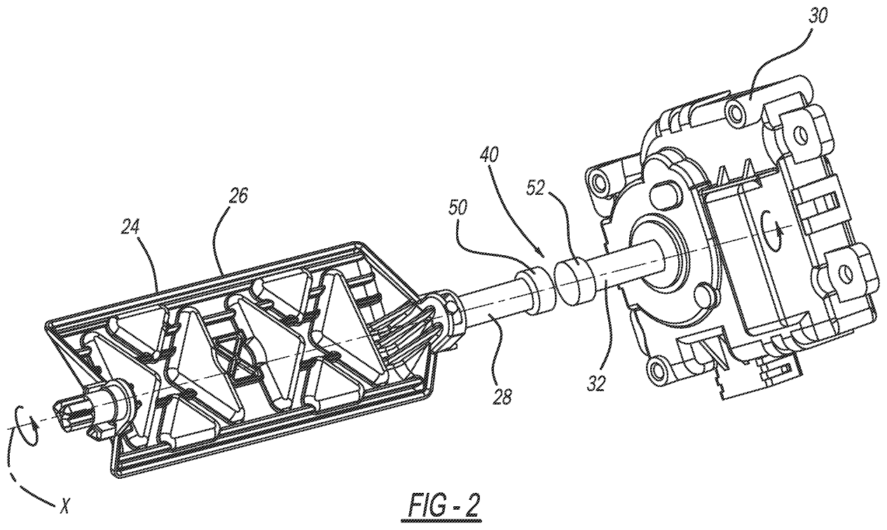

With continued reference to FIG. 1 and additional reference to FIG. 2, the magnetic linkage 40 will now be described in additional detail. The magnetic linkage 40 includes a first magnet 50 at the end of a post 28 of the airflow control member 24. The first magnet 50 generates a first magnetic field. The magnetic linkage 40 further includes a second magnet 52, which is at the end of a rod 32 of the servo 30. Both the post 28 and the rod 32 are arranged along the axis of rotation X. The second magnet 52 generates a second magnetic field, which has a polarity opposite to a polarity of the first magnetic field of the first magnet 50. The first and second magnets 50, 52 may be spaced apart from one another as illustrated, or may contact one another. The first and second magnets 50, 52 are positioned such that the first magnetic field of the first magnet 50 cooperates with the second magnetic field of the second magnet 52. Thus, rotation of the rod 32 by the servo 30 rotates the airflow control member 24 on the axis of rotation A by way of the magnetic linkage 40.

The airflow control member 24 is mounted within the HVAC case 20 in any suitable manner. For example, the post 28 may also be a mounting post, which supports the airflow control member 24 at a sidewall 34 of the HVAC case 20. Thus, the post 28 may extend through an opening in the sidewall 34, and the interface between the first magnet 50 and the second magnet 52 may be exterior to the HVAC case 20. Alternatively, the interface between the first and second magnets 50, 52 may be within the HVAC case 20. Another option is for the interface between the first and second magnets 50, 52 to be within the sidewall 34. When the control module 110 determines that the airflow control member 24 should be rotated to a particular predetermined position based on temperature and/or airflow requirements of a user, the control module 110 operates the servo 30 to rotate the rod 32 and the second magnet 52, which rotates the first magnet 50 and the rest of the airflow control member 24 on the axis of rotation X.

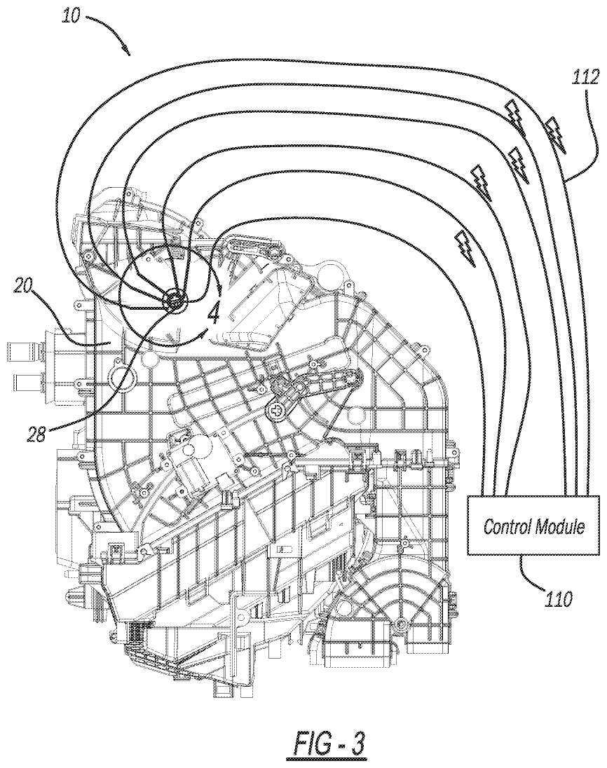

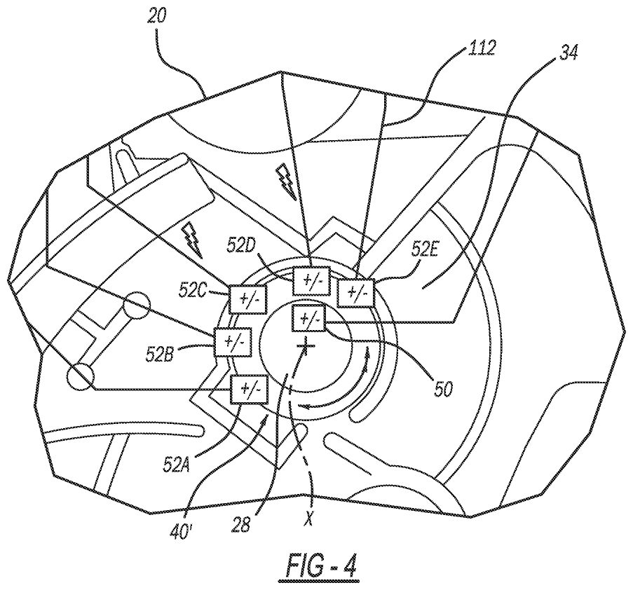

With additional reference to FIGS. 3 and 4, the present disclosure includes another magnetic linkage 40′, which may take the place of magnetic linkage 40. The magnetic linkage 40′ includes the first magnet 50 mounted to the post 28 of the airflow control member 24. The first magnet 50 may be arranged along the axis of rotation X, or off-center therefrom. The first magnet 50 may be a permanent magnet, or an electromagnet. When configured as an electromagnet, the first magnet 50 is connected to the control module 110, which is configured to energize the first magnet 50, as well as control the strength and polarity thereof. The first magnet 50 is connected to the control module 110 by any suitable conductor, such as wire 112.

In the configuration of FIGS. 3 and 4, a plurality of second magnets 52A, 52B, 52C, 52D, and 52E are mounted about the post 28 and the first magnet 50 mounted thereto. Although five second magnets 52A-52E are illustrated, any suitable number of second magnets 52 may be included. Second magnets 52A-52E may be mounted at any suitable position allowing for magnetic cooperation between the first magnet 50 and the second magnets 52A-52E as the airflow control member 24 rotates on the longitudinal axis X. For example, the second magnets 52A-52E may be mounted on an exterior of the sidewall 34. Alternatively, the second magnets 52A-52E may be mounted within the sidewall 34 around the hole defined therein through which the post 28 extends. Still further, the second magnets 52A-52E can be mounted within the HVAC case 20 within magnetic range of the first magnet 50.

Each one of the second magnets 52A-52E is an electromagnet powered by the control module 110. The control module 110 is connected to the second magnets 52A-52E by way of any suitable electrical conduits, such as wires 112. The control module 110 is configured to control individual strength and polarity of each one of the second magnets 52A-52E.

The control module 110 is configured to control the strength and polarity of the second magnets 52A-52E (and optionally the first magnet 50) in a manner suitable to rotate the airflow control member 24 to any suitable position by way of the magnetic linkage 40′. For example, FIG. 4 illustrates the airflow control member 24 positioned with the first magnet 50 opposite to the second magnet 52D. To rotate the airflow control member 24 clockwise, the control module 110 configures the second magnet 52E to have a polarity that is opposite to the first magnet 50 in order to draw the first magnet 50 towards the second magnet 52E, which will rotate the post 28 (and the airflow control member 24) clockwise. To further assist with clockwise rotation of the post 28, the control module 110 may also configure the polarity of the second magnet 52D to be the same as the first magnet 50, which will result in the first magnet 50 and the second magnet 52D being repelled apart. The control module 110 may also configure the second magnet 52C (and even the second magnets 52A, 52B) to also be the same as the first magnet 50, thereby further forcing the first magnet 50 away from the second magnets 52A-52C towards and to the second magnet 52E.

To rotate the airflow control member 24 counterclockwise so the first magnet 50 is at or proximate to the second magnet 52A, for example, the control module 110 sets the polarity of the second magnet 52A to be opposite to the first magnet 50 so that the first magnet 50 will be attracted to the second magnet 52A. The control module 110 sets the polarity of the second magnets 52E, 52D to be the same as the first magnet 50 in order to repel the first magnet 50 away from the second magnets 52D, 52E. The control module 110 sets the polarity of the second magnets 52B, 52C to be opposite to the first magnet 50 in order to rotate the first magnet 50 towards the second magnet 52A. Once the first magnet 50 moves to each of the second magnets 52B, 52C, the control module 110 will change the polarity of the second magnets 52B, 52C to a polarity that is the same as the first magnet 50 in order to push the first magnet 50 towards the second magnet 52A. Thus, by selectively changing the strength and polarity of the second magnets 52A-52E (and/or optionally the strength and polarity of the first magnet 50) the control module 110 rotates the post 28 and the panel 26 to a desired position within the HVAC case 20 in order to control airflow in a manner corresponding to an HVAC mode requested by a user. The magnetic linkage 40′ is advantageously able to move the airflow control member 24 to nearly an infinite number of different positions. For example, in addition to rotating the airflow control member 24 such that the first magnet 50 is opposite to any one of the second magnets 52A-52E, the control module 110 can control the strength and polarity of the second magnets 52A-52E (and/or the first magnet 50) to move the first magnet 50 to any position between any two of the second magnets 52A-52E.

The present disclosure thus provides for magnetic linkages 40, 40′, which have numerous advantages over traditional mechanical linkages. For example and as compared with mechanical linkages, the magnetic linkages 40, 40′ are generally easier to assemble, more reliable, more precise, quieter, and less costly. One skilled in the art will appreciate that the present disclosure provides numerous additional advantages and unexpected results in addition to those set forth above.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A vehicle heating, ventilation, and air conditioning (HVAC) system comprising:
an HVAC case;
an airflow control member mounted within the HVAC case and rotatable about an axis of rotation;
a first magnet at or adjacent to the axis of rotation and movable along with the airflow control member, the first magnet generates a first magnetic field; and
a second magnet spaced apart from the first magnet, the second magnet generates a second magnetic field having a polarity that is opposite to the first magnetic field;
wherein magnetic cooperation between the first magnet and the second magnet provides a magnetic linkage for rotating the airflow control member within the HVAC case.

2. The HVAC system of claim 1, wherein the airflow control member is a valve or door.

3. The HVAC system of claim 1, wherein the first magnet is mounted to the airflow control member.

4. The HVAC system of claim 1, wherein the first magnet is mounted on the axis of rotation of the airflow control member.

5. The HVAC system of claim 4, wherein the first magnet is mounted at an end of a post of the airflow control member, the post extending along the axis of rotation of the airflow control member.

6. The HVAC system of claim 1, wherein the second magnet is rotatable by a servomotor.

7. The HVAC system of claim 6, wherein the second magnet is mounted to an end of a rod in cooperation with the servomotor for rotation by the servomotor.

8. The HVAC system of claim 1, wherein the first magnet is mounted to a post of the airflow control member, the post extending along the axis of rotation of the airflow control member; and
wherein the second magnet is mounted to the HVAC case proximate to the post.

9. The HVAC system of claim 8, wherein the post is in cooperation with the HVAC case;
wherein the second magnet is one of a plurality of second magnets mounted to the HVAC case spaced apart about the post, each one of the plurality of second magnets generates a second magnetic field; and
wherein the HVAC system further comprises a control module configured to individually control polarity and magnetic strength of each one of the second magnets to move the first magnet to one of the plurality of second magnets, thereby rotating the airflow control member.

10. A vehicle heating, ventilation, and air conditioning (HVAC) system comprising:
an HVAC case;
an airflow control member mounted within the HVAC case;
a servomotor mounted to the HVAC case; and
a magnetic linkage between the airflow control member and the servomotor;
wherein the servomotor rotates the airflow control member by way of the magnetic linkage.

11. The HVAC system of claim 10, wherein the magnetic linkage includes a first magnet coupled to the airflow control member, and a second magnet rotatable by the servomotor, a first magnetic field of the first magnet is in cooperation with a second magnetic field of the second magnet such that rotation of the second magnet by the servomotor rotates the first magnet and the airflow control member.

12. The HVAC system of claim 11, wherein the airflow control member is rotatable on an axis of rotation, and both the first magnet and the second magnet are aligned along the axis of rotation and rotate on the axis of rotation.

13. The HVAC system of claim 12, wherein the first magnet is mounted to a support post of the airflow control member.

14. A vehicle heating, ventilation, and air conditioning (HVAC) system comprising:
an HVAC case;
an airflow control member mounted to the HVAC case and rotatable on an axis of rotation;
a first magnet mounted to the airflow control member;
a plurality of second magnets mounted to the HVAC case about the first magnet; and
a control module configured to individually control polarity of each one of the plurality of the second magnets to move the first magnet to one of the plurality of second magnets, thereby rotating the airflow control member on the axis of rotation.

15. The HVAC system of claim 14, wherein the airflow control member includes a support post arranged along the axis of rotation, and the first magnet is mounted to the support post.

16. The HVAC system of claim 15, wherein the plurality of second magnets are spaced apart about the axis of rotation, each location of the plurality of second magnets corresponds to a predetermined position of the airflow control member.

17. The HVAC system of claim 14, wherein the control module is further configured to control polarity of the first magnet.

18. The HVAC system of claim 14, wherein the control module is further configured to control magnetic strength of the first magnet and each one of the plurality of second magnets.

19. The HVAC system of claim 14, wherein the airflow control member is a door or valve.
